(19) United States
(12) Patent Application Publication
(10) Pub. No.: US 2015/0181864 A1
(43) Pub. Date: Jul. 2, 2015

(54) ADJUVANT BLEND FOR PESTICIDE FORMULATIONS

(71) Applicant: HUNTSMAN PETROCHEMICAL LLC, The Woodland, TX (US)

(72) Inventors: Dave C Ferguson, Spring, TX (US); Matthew T Meredith, Spring, TX (US); R Scott Tann, Sugar Land, TX (US)

(21) Appl. No.: 14/380,091

(22) PCT Filed: Aug. 26, 2013
(86) PCT No.: PCT/US13/56601

§ 371 Date: Aug. 21, 2014

Related U.S. Application Data
(60) Provisional application No. 61/697,382, filed on Sep. 6, 2012.

(51) Int. Cl. A01N 25/30

(52) U.S. Cl. CPC A01N 25/30

(57) ABSTRACT

The present invention provides an adjuvant blend that includes an alkyl ester obtained from the reaction of acidulated soap stock with a C₃-C₂₀ alcohol and a nonionic surfactant. The adjuvant blend may be incorporated into pesticide formulations and applied to target substrates to kill, inhibit, or repel pests.

### CROSS-REFERENCE TO RELATED APPLICATION

Not Applicable.

### STATEMENT REGARDING FEDERALLY SPONSORED RESEARCH OR DEVELOPMENT

Not Applicable.

### FIELD OF THE INVENTION

The present disclosure is directed to an adjuvant blend containing an alkyl ester obtained from the alkylation of acidulated soap stock and a nonionic surfactant. The adjuvant blend can be combined with a pesticide to improve the efficacy thereof.

### BACKGROUND OF THE INVENTION

Farmers, homeowner's etc. have commonly used pesticides to control undesired proliferation of weeds, insects, rodents, and the like. Pesticide chemicals in their unformulated state are usually not suitable for pest control. These concentrated chemicals (i.e. “active” ingredients”) may not mix well with water, may be chemically unstable, and may be difficult to handle or transport. For these reasons, other components are typically added to improve application effectiveness, safety, handling, and storage. The mixture of active ingredients with these other components is often referred to as a pesticide formulation. One such component which may be used in combination with a pesticide is an adjuvant. Adjuvants, premixed in the pesticide formulation before packaging or added to a spray tank prior to spraying, are designed to increase efficacy of the pesticide or to improve the application characteristics of the pesticide. Thus, adjuvants have been designed to improve the “wetting” of drops during spraying, to alter the volatility of the spray mixture, to improve the rain-fastness of the herbicide on the plant, to improve the penetration or distribution of the active ingredient, to regulate pH of the spray mix, to improve compatibility of the various components in a mix tank, and to reduce drift during spraying. Since the adjuvant acts in some manner to improve the effectiveness of the active ingredient, the amount of active ingredient needed to be effective can be reduced in many cases, without a loss in efficacy.

There is no universal adjuvant that can improve the performance of all pesticides. Thus, the pesticide and adjuvant selected, and the relative amounts used, must be tailored to the specific conditions of each application. Some examples include:

U.S. Pat. No. 5,495,033, which discloses a methylated acidulated soybean soap stock which can be used as an adjuvant for various herbicides;

U.S. Pat. No. 5,521,144, which teaches an adjuvant for post-emergent herbicides that includes acidulated soap stock combined with an alkylphenol ethoxylate or a blend of an alcohol ethoxylate and glycol ether or an anionic surfactant;

U.S. Pat. No. 5,658,855, which describes an adjuvant composition containing an amine or ammonia compound, an ammonium salt, a nonionic surfactant having a high HLB, and water;

U.S. Pat. No. 5,888,934, which discloses an adjuvant for improving rainfastness including an alkyl polyglucoside and an ethoxylated alcohol obtained from the ethoxylation of an aliphatic mono alcohol;

U.S. Pat. No. 5,928,563, which teaches an adjuvant containing a sulfated alkyl oleate, an alkyl polyglucoside and a C₆-C₁₈ alkyl ester;

U.S. Pat. No. 5,942,542, which describes an adjuvant for use with a pyrethroid insecticide comprising an alkyl ester of a fatty acid having a level of unsaturation of at least 40% or an alkyl ester of a dibasic acid and a nonionic emulsifier;

US 2003/0104947, which discloses an adjuvant for use in a spray carrier containing a petroleum oil, a pH adjuster, and a nonionic surfactant;

U.S. Pat. No. 6,642,178, which teaches an adjuvant for use in spray carriers comprising a nitrogen fertilizer, a modified vegetable oil, a pH adjuster and a blend of high, intermediate and low HLB nonionic surfactants;

WO 2004/080177, which describes an adjuvant in the form of a microemulsion form containing a hydrocarbon or fatty acid ester, an alkyl polyglucoside, a glycerol or sorbitan ester, and water; and

US 2011/0201504, which discloses an adjuvant mixture containing a fatty acid alkyl ester, at least two non-ionic surfactants selected from alkyl polyglucosides, sorbitol esters, and polyglyercol esters and optionally a polyol.

### SUMMARY OF THE INVENTION

The present disclosure provides an adjuvant blend comprising (i) an alkyl ester obtained from the reaction of acidulated soap stock with a C₃-C₂₀ alcohol; and (ii) a nonionic surfactant.

In another aspect, the present disclosure provides a pesticide formulation for application onto a target substrate to elicit a chemical or biological effect. The pesticide formulation comprises a pesticidally effective amount of a pesticide or a mixture of pesticides and the adjuvant blend. The adjuvant blend is present in the pesticide formulation at a concentration such that the pesticidal efficacy of the pesticide formulation is enhanced as compared to a reference pesticide formulation devoid of one or both of components (i) and (ii) of the adjuvant blend but otherwise having the same ingredients as the pesticide formulation. Thus, the addition of such adjuvant blends to the pesticide formulation makes possible a faster uptake of active ingredients by a target substrate treated with the pesticide formulation. This enhanced activity may give rise to the following aspects in the treatment of a target substrate with the pesticide formulation: a comparatively greater activity of the active ingredient at a given application rate; a comparatively lower application rate at a given activity; a comparatively greater uptake of the active ingredient by the target substrate.

In still a further aspect, the present disclosure provides a method for killing, inhibiting or repelling a pest which includes: providing the pesticide or a mixture of pesticides in a pesticidally effective amount; providing an effective amount of the adjuvant blend, combining the pesticide or mixture of pesticides with the adjuvant blend to form a pesticide formulation, and contacting the pesticide formulation and the pest.

### DETAILED DESCRIPTION OF THE INVENTION

The present disclosure provides an adjuvant blend for use with pesticides that is made from (i) an alkyl ester obtained from the reaction of acidulated soap stock with a C₃-C₂₀ alcohol; and (ii) a nonionic surfactant. It has been surprisingly found combining these components produces an adjuvant blend that may be used in pesticide formulations to enhance efficacy of the active ingredients in the formulation. By “enhanced” it is to be understood that the adjuvant blend of the present disclosure increases the performance of the active ingredients in pesticide formulations, for example, higher activity of the active ingredients for a given application rate, lower application rate with a given effect, better uptake of the active ingredient by the target substrate, and thus advantages for a pre-emergence or post-emergence treatment, in particular the spray treatment of target substrates, as compared to pesticide formulations where only one or none of the adjuvant blend components are present.

As used herein, the term “HLB” or “hydrophilic/lipophilic balance index” is a numerical index for a given surfactant structure, indicating its balance of hydrophilic and lipophilic properties. A surfactant with a high HLB is more hydrophilic and less lipophilic in character than a surfactant with a low HLB.

Additionally, a “pesticidally effective amount” refers to that amount of a pesticide which, upon application, either reduces the presence of pests, or enhances a plant's resistance to a pest.

Also, the term “target substrate” refers to sites underlying plant foliage which are the intended destination for the pesticide including, but not limited to, natural ground surfaces such as soil, water (lakes, ponds, marshes, swamps, streams, puddles, etc.) and artificial surfaces such as pavement; a pest; or a combination thereof

A “pest” generally includes insects, mites, ticks and other arthropods; disease agents such as fungi, protozoa, bacteria and viruses; helminths, nematodes (roundworms), cestodes (tapeworms), platyhelminths (flatworms), trematodes (flukes) and other worms; sporozoan parasites; slugs and snails; and vertebrates such as birds, rodents or other vertebrates which can directly or indirectly injure or cause disease or damage in any plant or part thereof or any processed, manufactured or other product of the plant.

In addition, the term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or more than one (i.e. to at least one) of the grammatical object of the article. By way of example, “a nonionic surfactant” means one nonionic surfactant or more than one nonionic surfactant.

The phrases “in one embodiment”, “according to one embodiment” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

### Adjuvant Blend

As a first component, the adjuvant blend of the present disclosure includes an alkyl ester obtained from the reaction of acidulated soap stock and a C₃-C₂₀ alcohol.

According to one embodiment, the acidulated soap stocks used in the reaction of the present disclosure represent commercially available organic products obtained from the acidulation of soap stock. Soap stock is a by-product of alkali refining of crude vegetable or animal oils. During the alkali refining process, the crude oil is treated with a small percentage, for example about 0.1-3% by weight, of an alkali, for example, sodium hydroxide or sodium bicarbonate. This treatment forms sodium salts of the free fatty acids, which salts (“soap stock”) precipitate out as a solid and are removed from the oil by centrifugation or settling. The soap stock is then treated with an acid, such as sulfuric acid, nitric acid, phosphoric acid or hydrochloric acid in an acidulation step to disassociate the fatty acid salts. The acidulated soap stock is then recovered by decantation or centrifugation.

Crude oils containing free fatty acids that may be readily refined into soap stock can be obtained from vegetable or animal origin including, but not limited to, soybean oil, cottonseed oil, peanut oil, corn oil, sunflower oil, safflower oil, coconut oil, olive oil, linseed oil, oleo oil, wheat oil, rice oil, rapseed oil, poppyseed oil, sardine oil, and menhaden oil.

In one embodiment, the alcohol which is reacted with the acidulated soap stock is a straight chain or branched alcohol having three to twenty carbon atoms. Examples include, but are not limited to, propanol, isopropanol, isobutanol, n-butanol, ethylene glycol, glycerol, 1,3-propanediol, 1,4-butane diol, 1,5- pentane diol, 1,6-hexane diol, 1,7-heptanediol, pinacol, pentaerythritol, trimethylolmethane, and sorbitol. Thus, in one particular embodiment, the C₃-C₂₀ alcohol is selected from isobutanol, n-butanol, ethylene glycol or 2-ethylhexanol.

The esterification of the acidulated soap stock may be carried out by means well known to those skilled in the art. In one embodiment, the acidulated soap stock is charged to a reactor with an excess of alcohol, for example about 1.5-4 molar excess of alcohol, and a concentration of about 0.1-1% of an acidic catalyst by weight of the acidulated soap stock to form a reaction mixture. In one embodiment, the acidic catalyst may be a homogeneous catalyst, such as sulfuric acid, KHSO₄, p-toluene sulfonic acid, methane sulfonic acid, and the like, or it may be a heterogeneous catalyst, such as a strongly acidic sulfonated ion exchange resin or an acidic zeolite catalyst.

The reaction mixture is then heated at moderate temperature, such as within the range of about 25° C. to about 150° C. to allow esterification to proceed. Higher temperatures (for e.g. up to the boiling point of the alcohol) may be utilized but are generally not preferred. Also, esterification proceeds quickly and with a high degree of completion at atmospheric pressure; however, greater than atmospheric pressure (for e.g. up to about 300 psi) may be utilized if desired. Depending on the alcohol used, the reaction time may be up to about 50 hours, in other embodiments, up to about 10 hours, in still other embodiments, up to about 5 hours, in still further embodiments up to about 2 hours, while in other embodiments, up to about 0.5 hours. Prefereably, water, as a byproduct of the reaction, is removed as the reaction progresses to drive the reaction forward. Water may be removed by distillation with or without an azeotrope such as toluene. Some alcohols used for esterification (eg propanol, isopropanol, n-butanol, isobutanol) may act azeotropically themselves and aid in water removal. Once the reaction has gone to substantial completion, the excess alcohol may be recovered via an evaporator and the remaining alkyl ester reaction product may be washed and dried.

As a second component, the adjuvant blend of the present disclosure also includes a nonionic surfactant. As used herein, a nonionic surfactant relates to one nonionic surfactant having an HLB ranging from about 5 to about 20, preferably from about 7 to about 14, or a mixture of two or more nonionic surfactants having a weighted mean HLB in accordance the above values. Such nonionic surfactants are well known to those of ordinary skill in the art and include alkoxylated C₈₋₂₀ alcohols and alkyl phenols. The alkoxylated alcohols may be ethoxylated alcohols, propoxylated alcohols and/or a mixture of ethoxylated/propoxylated alcohols. Surfactant catalogs are available which list a number of these conventional nonionic surfactants, together with their respective HLB values, which may be used when choosing the nonionic sufactant.

Suitable chemical processes for preparing the nonionic surfactants for use herein include condensation of corresponding straight chain or branched alcohols with alkylene oxide in the desired proportions. Thus, an alcohol is used as an initiator molecule and an alkylene oxide or a mixture of alkylene oxides is polymerized onto the initiator molecule to form a first block. Thereafter, a second alkylene oxide or mixture of alkylene oxides can optionally be added to form a second block. Third and subsequent blocks can also be added. Alternatively, a great variety of alkoxylated alcohols suitable for use as nonionic surfactants are commercially available from various suppliers.

Preferred for use herein include polyethylene oxide ethers derived from lauryl alcohol, cetyl alcohol, oleyl alcohol, stearyl alcohol, isostearyl alcohol, myristyl alcohol, behenyl alcohol, and mixtures thereof. In addition, polyoxyethylene 10 cetyl ether, known by the CTFA designation as ceteth-10; polyoxyethylene (21) stearyl ether, known by the CTFA designation steareth-21; coconut alkyl polyethoxylate (6.5); decyl polyethoxylate (6); and mixtures thereof may also be used.

Examples of commercially available nonionic surfactants that may be used include one or a mixture of any of the following: SURFONIC® L12-6, SURFONIC® L12-8, SURFONIC® L24-2, SURFONIC® L24-3, SURFONIC® L24-4, SURFONIC® L24-5, SURFONIC® L24-7, SURFONIC® L24-9, SURFONIC® L24-12, SURFONIC® L24-22, SURFONIC® LSF 23-9 and SURFONIC® L46-7 surfactants available from Huntsman Corporation. Other examples include TERGITOL® 15S9 surfactant (The Dow Chemical Company), and NEODOL® 91-8 NEODOL® 23-9, NEODOL® 45-9 surfactants (Shell Chemicals). Other commercial sources of such surfactants can be found in McCutcheon's EMULSIFIERS AND DETERGENTS, North American Edition, 2000, McCutcheon Division, MC Publishing Company, which is incorporated herein by reference.

Optionally, the adjuvant blend and/or the pesticide formulation disclosed below may further include formulation auxiliaries such as: anionic surfactants, for example, salts of fatty acids, alkyl sulphates, alkyl ether sulphonates and alkyl aryl sulphonates; cationic surfactants, for example, primary amine salts, diamine salts, quaternary ammonium salts, and ethoxylated amines; amphoteric and zwitterionic surfactants, for example, alkylbetaines, amine oxides, polycarboxylates, alkyl aminopropionic acids, alkyl iminopropionic acids, imidazoline carboxylates, sulfobetaines, and sultaines; emulsifiers, for example, alkyl polyglycosides, fatty alcohols or fatty alcohol polyol ethers; and spreaders, for example, dimethyl polysiloxanes, methylphenyl polysiloxanes, cyclic silicones and amino-, fatty acid-, alcohol-, polyether-, epoxy-, fluorine-, glycoside- and/or alkyl-modified silicone compounds.

Other optional formulation auxiliaries may include: preservatives, inorganic or organic acids to neutralize the pH, clarifiers, such as propylene glycol, stabilizers, wetting agents, antifreeze agents, antifoam agents, dyes, thickening agents, and inorganic salts.

anti-drift agents, substances for influencing moisture (humectants), fertilizers such as ammonium sulfate, urea or compound fertilizers, for example phosphorus-, potash- and nitrogen-based compound fertilizers, such as P, K, N fertilizers, UV stabilizers, solvents, for example polar solvents such as waters or alcohols, or unpolar solvents such as saturated or unsaturated aliphatic solvents, which may be branched or unbranched, or aromatic solvents.

### Formulating the Adjuvant Blend

To make adjuvant blends of the present disclosure, the individual components disclosed above are provided and combined together by customary methods, for example, mixing by dissolving or emulsifying the individual components in any suitable vessel or container, preferably at room temperature. The relative levels of the components are selected to give the required performance with an eye toward making sure on the one hand that a component is present at a sufficient level to be effective, but on the other hand that excessive cost is avoided by limiting the upper range of the component. The order of mixing the components is not particularly important and generally the individual components can be added sequentially or all at once.

Thus, in one embodiment, the alkyl ester obtained from the reaction of acidulated soap stock and C₃-C₂₀ alcohol and the nonionic surfactant are combined together to form an adjuvant blend at a weight ratio of alkyl ester to nonionic surfactant ranging from about 4:1 to about 24:1; in another embodiment ranging from about 7:1 to about 19:1; and in still another embodiment ranging from about 11:1 to about 15:1.

According to other embodiments, the adjuvant blend includes (i) at least about 80% by weight of the alkyl ester obtained from the reaction of acidulated soap stock and C₃-C₂₀ alcohol and (ii) at least about 3% by weight of the nonionic surfactant, where the % by weight is based on the total weight of the adjuvant blend. In another embodiment, the adjuvant blend includes (i) at least about 85% by weight of the alkyl ester obtained from the reaction of acidulated soap stock and C₃-C₂₀ alcohol and (ii) at least about 5% by weight of the nonionic surfactant, where the % by weight is based on the total weight of the adjuvant blend.

In yet another embodiment, the adjuvant blend includes (i) less than about 97% by weight of the alkyl ester obtained from the reaction of acidulated soap stock and C₃-C₂₀ alcohol and (ii) less than about 15% by weight of the nonionic surfactant, where the % by weight is based on the total weight of the adjuvant blend. In another embodiment, the adjuvant blend includes (i) less than about 95% by weight of the alkyl ester obtained from the reaction of acidulated soap stock and C₃-C₂₀ alcohol and (ii) less than about 12% by weight of the nonionic surfactant, where the % by weight is based on the total weight of the adjuvant blend.

In still another embodiment, the adjuvant blend includes (i) about 80-97% by weight of the alkyl ester obtained from the reaction of acidulated soap stock and C₃-C₂₀ alcohol and (ii) about 3-20% by weight of the nonionic surfactant, where the % by weight is based on the total weight of the adjuvant blend. In another embodiment, the adjuvant blend includes (i) about 87-95% by weight of the alkyl ester obtained from the reaction of acidulated soap stock and C₃-C₂₀ alcohol and (ii) about 5-13% by weight of the nonionic surfactant, where the % by weight is based on the total weight of the adjuvant blend.

### Pesticide Formulation

Another object of the present disclosure is directed to a pesticide formulation comprising a pesticide and the adjuvant blend described above. The pesticide formulation may be used in treating target substrates such as those disclosed above and may be in the form of a co-formulation or tank mix. The presently described adjuvant blend is not limited for use with any particular class of pesticides. A pesticide formulation of the presently described technology can comprise a pesticide or a mixture of pesticides.

The pesticide formulations according to the present disclosure can be prepared by customary processes, for example mixing by grinding, dissolving or dispersing the individual components, preferably at room temperature. If other formulation auxiliaries are present, they are preferably likewise incorporated at room temperature. In general, the sequence in which the individual components are added is of no decisive importance. In addition, the adjuvant blend and pesticide of the pesticide formulations according to the present disclosure may be present together in a readymix package which can be applied in the customary fashion, for example in the form of a spray mixture, or the adjuvant blend and pesticide can be formulated separately in their own packages and added to a spray tank prior to use. Thus, in a preferred embodiment, the adjuvant blend disclosed above may be formulated in a container, for example, in a steel, tin, or aluminum can, plastic or glass bottle and paper or cardboard containers, to produce a tank mix adjuvant. The tank mix adjuvant may then be used to make up a spray mixture prior to application; the spray mixture thus including the tank mix adjuvant, a pesticide and spray water or other solvent.

In one embodiment, the pesticide includes any chemical or biological agent (i.e. “active ingredient”) used in preventing, destroying, repelling, or mitigating a pest. Thus, in one particular embodiment, the pesticide is a fungicide, herbicide, insecticide, algicide, molluscicide, miticide, rodenticide, or insect repellant.

According to one embodiment, the pesticide is a fungicide. Examples of fungicides include, but are not limited to: azoxystrobin, trifloxystrobin, kresoxim methyl, famoxadone, metominostrobin and picoxystrobin, carbendazim, thiabendazole, dimethomorph, vinclozolin, iprodione, dithiocarbamate, imazalil, prochloraz, fluquinconazole, epoxiconazole, flutriafol, azaconazole, bitertanol, bromuconazole, cyproconazole, difenoconazole, hexaconazole, paclobutrazole, propiconazole, tebuconazole, triadimefon, trtiticonazole, fenpropimorph, tridemorph, fenpropidin, mancozeb, metiram, chlorothalonil, thiram, ziram, captafol, captan, folpet, fluazinam, flutolanil, carboxin, metalaxyl, bupirimate, ethirimol, dimoxystrobin, fluoxastrobin, orysastrobin, metominostrobin, prothioconazole, 8-(2,6-diethyl-4-methyl-phenyl)tetrahydropyrazolo[1,2-d][1,4,5]oxadiazepi-ne-7,9-dione, 2,2,-dimethyl-propionic acid-8-(2,6-diethyl-4-methyl-phenyl)-9-oxo-1,2,4,5-tetrahydro-9H-pyrazolo-[1,2 d][1,4,5]oxadiazepine-7-yl ester and metalaxyl.

In another embodiment, the pesticide is a herbicide. Examples of herbicides include, but are not limited to: fluzifop, mesotrione, fomesafen, tralkoxydim, napropamide, amitraz, propanil, cyprodanil, pyrimethanil, dicloran, tecnazene, toclofos methyl, flamprop M, 2,4-D, MCPA, mecoprop, clodinafop-propargyl, cyhalofop-butyl, diclofop methyl, haloxyfop, quizalofop-P, indol-3-ylacetic acid, 1-naphthylacetic acid, isoxaben, tebutam, chlorthal dimethyl, benomyl, benfuresate, dicamba, dichlobenil, benazolin, triazoxide, fluazuron, teflubenzuron, phenmedipham, acetochlor, alachlor, metolachlor, pretilachlor, thenylchlor, alloxydim, butroxydim, clethodim, cyclodim, sethoxydim, tepraloxydim, pendimethalin, dinoterb, bifenox, oxyfluorfen, acifluorfen, fluoroglycofen-ethyl, bromoxynil, ioxynil, imazamethabenz-methyl, imazapyr, imazaquin, imazethapyr, imazapic, imazamox, flumioxazin, flumiclorac-pentyl, picloram, amodosulfuron, chlorsulfuron, nicosulfuron, rimsulfuron, triasulfuron, triallate, pebulate, prosulfocarb, molinate, atrazine, simazine, cyanazine, ametryn, prometryn, terbuthylazine, terbutryn, sulcotrione, isoproturon, linuron, fenuron, chlorotoluron, metoxuron, N-phosphonomethylglycine and its salts (glyphosate), glufosinate, chlormequat chloride, paraquat, diquat, trifloxysulfuron, fomesafen, mesotrione and fenuron.

In still another embodiment, the pesticide is an insecticide. Examples of insecticides include, but are not limited to: abamectin, acephate, acetamiprid, acrinathrin, alanycarb, aldicarb, allethrin, alpha-cypermethrin, amitraz, asulam, azadirachtin, azamethiphos, azinphos-ethyl, azinphos-methyl, bendiocarb, benfuracarb, bensultap, beta-cyfluthrin, beta-cypermethrin, bifenthrin, bioallethrin, bioresmethrin, bistrifluron, borax, buprofezin, butoxycarboxim, cadusafos, carbaryl, carbofuran, chlorpropham, clothianidin, cyfluthrin, cyhalothrin, cyprmethrin, deltamethrin, diethofencarb, diflubenzuron, dinotefuran, emamectin, endosulfan, fenoxycarb, fenthion, fenvalerate, fipronil, halfenprox, heptachlor, hydramethylnon, imidacloprid, imiprothrin, isoprocarb, lambda cyhalothrin, methamidophos, methiocarb, methomyl, nitenpyram, omethoate, permethrin, pirimicarb, pirimiphos methyl, propoxur, tebufenozide, thiamethoxam, thiodicarb, triflumoron, and xylylcarb.

In a further embodiment, the pesticide is an algicide. Examples of algicides include, but are not limited to: bethoxazin, copper dioctanoate, copper sulfate, cybutryne, dichlone, dichlorophen, endothal, fentin, hydrated lime, nabam, quinoclamine, quinonamid, simazine, triphenyltin acetate, and triphenyltin hydroxide.

In another embodiment, the pesticide is a molluscicide. Examples of moluscicides include, but are not limited to: metaldehyde, methiocarb and aluminium sulfate.

In yet another embodiment, the pesticide is a miticide. Examples of miticides include, but are not limited to: antibiotic miticides, carbamate miticides, formamidine miticides, mite growth regulators, organochlorine, permethrin and organophosphate miticides.

In still another embodiment, the pesticide is a rodenticide. Examples of rodenticides include, but are not limited to: 2-isovalerylindan-1,3-dione, 4-(quinoxalin-2-ylamino)benzenesulfonamide, alpha-chlorohydrin, aluminium phosphines, anta, arsenics oxide, barium carbonate, bisthiosemi, brodifacoum, bromadiolone, bromethalin, calcium cyanide, chloralose, chlorophacinone, cholecalciferol, coumachlor, coumafuryl, coumatetralyl, crimidine, difenacoum, difethialone, diphacinone, ergocalciferol, flocoumafen, fluoroacetamide, flupropadine, flupropadine hydrochloride, gamma-HCH, HCH, hydrogen cyanide, iodomethane, lindane, magnesium phosphide, methyl bromide, norbormide, phosacetim, phosphine, phosphorus, pindone, potassium arsenite, pyrinuron, scilliroside, sodium arsenite, sodium cyanide, sodium fluoroacetate, strychnine, thallium sulfate, warfarin, and zinc phosphide.

In an additional embodiment, the pesticide is an insect repellant. Examples of insect repellants, include, but are not limited to: 2-ethyl-1,3-hexanediol; N-octyl bicycloheptene dicarboximide; N,N-diethyl-M-toluamide; 2,3:4,5-Bis (2-butylene) tetrahydro-2-furaldehyde; Di-n-propyl isocinchomeronate; and 2-hydroxyethyl-n-octyl sulfide.

The amount of pesticide included in the pesticide formulation of the present disclosure will vary according to a number of parameters such as the target substrate to be treated, the area to be treated, etc. In general, a rate of application from about five grams to about four kilograms per hectare (g/ha) of pesticide may be suitable. The amount of the adjuvant blend in the pesticide formulation may be from about 0.01-99% by weight, based on the total weight of the pesticide formulation.

Therefore, the adjuvant blends of the present disclosure may be used in conventional agricultural methods. For example, the pesticide or mixture of pesticides and adjuvant blend may be mixed with water or other solvent(s) and/or fertilizers and applied post-emergence to a desired target substrate by any means, such as airplane spray tanks, knapsack spray tanks, cattle dipping vats, farm equipment used in ground spraying (e.g., boom sprayers, hand sprayers), and the like.

In accordance with another embodiment, the presently described technology provides a method for killing or inhibiting or repelling a pest comprising the steps of providing a pesticide or a mixture of pesticides in a pesticidally effective amount; providing an effective amount of an adjuvant blend, combining the pesticide or mixture of pesticides with the adjuvant blend to prepare a pesticide formulation, and contacting the pesticide formulation and the pest.

Although making and using various embodiments of the present invention have been described in detail above, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

What is claimed is:

1. An adjuvant blend comprising (i) an alkyl ester obtained from the reaction of acidulated soap stock with a C₃-C₂₀ alcohol; and (ii) a nonionic surfactant.

2. The adjuvant blend according to claim 1, wherein the C₃-C₂₀ alcohol is a straight chain or branched alcohol.

3. The adjuvant blend according to claim 2, wherein the C₃-C₂₀ alcohol is selected from the group consisting of propanol, isopropanol, isobutanol, n-butanol, ethylene glycol, glycerol, 1,3-propanediol, 1,4-butane diol, 1,5- pentane diol, 1,6-hexane diol, 1,7-heptanediol, pinacol, pentaerythritol, trimethylolmethane, and sorbitol.

4. The adjuvant blend according to claim 2, wherein the C₃-C₂₀ alcohol is n-butanol, ethylene glycol or 2-ethylhexanol.

5. The adjuvant blend according to claim 1, wherein the nonionic surfactant has an HLB ranging from about 5 to about 20.

6. The adjuvant blend according to claim 1, wherein the nonionic surfactant is an alkoxylated C₈₋₂₀ alcohol or alkyl phenol.

7. The adjuvant blend according to claim 1, wherein the adjuvant blend further comprises one or more formulation auxiliaries selected from anionic surfactants, cationic surfactants, amphoteric surfactants. zwitterionic surfactants, emulsifiers, spreaders, preservatives, inorganic or organic acids, clarifiers, stabilizers, wetting agents, antifreeze agents, antifoam agents, dyes, thickening agents, inorganic salts, anti-drift agents, humectants, fertilizers UV stabilizers, and solvents.

8. A method of making an adjuvant blend comprising: (a) providing an alkyl ester obtained from the reaction of acidulated soap stock and a C₃-C₂₀ alcohol; (b) providing a nonionic surfactant; (c) combining the alkyl ester and nonionic surfactant to form the adjuvant blend.

9. The method according to claim 8, wherein the alkyl ester obtained from the reaction of acidulated soap stock and C₃-C₂₀ alcohol and the nonionic surfactant are combined at a weight ratio of alkyl ester to nonionic surfactant ranging from about 4:1 to about 24:1.

10. The method according to claim 9, wherein at least about 85% by weight of the alkyl ester obtained from the reaction of acidulated soap stock and C₃-C₂₀ alcohol are combined with at least about 5% by weight of the nonionic surfactant, where the % by weight is based on the total weight of the adjuvant blend.

11. A pesticide formulation comprising a pesticide or mixture of pesticides and the adjuvant blend according to claim 1.

12. The pesticide formulation according to claim 11, wherein the pesticide is a fungicide, herbicide, insecticide, algicide, molluscicide, miticide, rodenticide, or insect repellant.

13. The pesticide formulation according to claim 11, wherein the pesticide formulation further comprises one or more formulation auxiliaries selected from anionic surfactants, cationic surfactants, amphoteric surfactants. zwitterionic surfactants, emulsifiers, spreaders, preservatives, inorganic or organic acids, clarifiers, stabilizers, wetting agents, antifreeze agents, antifoam agents, dyes, thickening agents, inorganic salts, anti-drift agents, humectants, fertilizers UV stabilizers, and solvents.

14. A container comprising the adjuvant blend according to claim 1.

15. A spray mixture comprising a pesticide, the adjuvant blend according to claim 1 and spray water or other solvent.

16. A method for killing or inhibiting or repelling a pest comprising the steps of providing a pesticide or a mixture of pesticides in a pesticidally effective amount;
providing an effective amount of an adjuvant blend according to claim 1, combining the pesticide or mixture of pesticides with the adjuvant blend to prepare a pesticide formulation, and contacting the pesticide formulation and the pest.
